(19) United States
(12) Patent Application Publication
(10) Pub. No.: US 2005/0248812 A1
(43) Pub. Date: Nov. 10, 2005

(54) Display adjustment apparatus and method, program, and image display print system

(76) Inventors: Hiroshi Udagawa, Tokyo (JP); Kohei Nojiri, Saitama (JP); Masato Nakamura, Kanagawa (JP)

Correspondence Address: William S. Frommer, Esq.;FROMMER LAWRENCE & HAUG LLP, 745 Fifth Avenue, New York, NY, 10151, US

(21) Appl. No.: 11/108,975

(22) Filed: Apr. 19, 2005

(30) Foreign Application Priority Data
Apr. 20, 2004 (JP) 2004-124791

(51) Int. Cl. H04N 5/21

(52) U.S. Cl. 358/3.01

(57) ABSTRACT

A display adjustment apparatus includes an:input section inputting an image; a luminance value changing section changing the luminance value of the image input by the input section on the basis of a predetermined adjustment parameter; an image output section outputting an image whose luminance value is changed by the luminance value changing section; and an adjustment parameter output section outputting an adjustment parameter used when the luminance value of the image is changed by the luminance value changing section.

### CROSS REFERENCES TO RELATED APPLICATIONS

The present invention contains subject matter related to Japanese Patent Application JP 2004-124791 filed in the Japanese Patent Office on Apr. 20, 2004, the entire contents of which are incorporated herein by reference.

### BACKGROUND OF THE INVENTION

1. Field of the Invention

The present invention relates to a display adjustment apparatus and method for making display adjustments on an input image, a program, and an image display print system for making display adjustments on an input image, displaying an image on which display adjustments are performed, and printing out the displayed image.

2. Description of the Related Art

At present, in the medical treatment field, medical diagnosis is performed by performing imaging of target areas of a patient with an electronic imaging device using X rays or MRI (magnetic resonance imaging), displaying the captured image on a display section such as a monitor, or printing it out.

Also, in order to observe in more detail a portion of a display image displayed on a display section or in accordance with the environmental conditions, such as the brightness of a room where the display section is placed, there are cases in which observations are desired to be made by changing the contrast of the display section and the luminance.

In the display section, such as a CRT, the characteristics of an input signal E versus display luminance L are non-linear, and this is called “gamma (γ) characteristics”. In general, the luminance L of a CRT varies proportionally to the γth power of an input signal E to the CRT. That is, L=KE^{γ} (in general, γ=2.2 to 3, K is a constant). Therefore, in order to make a correct gradation representation, it is necessary to add, to the CRT, a signal on which inverse correction of 1/γth power is performed in advance. This is called “γ correction”.

In general, the display section is provided with a gamma correction section so that the adjustment of gamma correction can be performed as desired. As disclosed in Japanese Unexamined Patent Application Publication No. 7-162714, an observer changes the display state of the display section to a desired one by adjusting the gamma correction section.

### SUMMARY OF THE INVENTION

However, hitherto, the adjustment and the change of gradation reproduction characteristics in the display section are only a temporary change on the display in the display section, and when the image is printed, the change is not reflected in the printed image.

As a result, a mismatch of gradation reproduction characteristics occurs between the image displayed on the display section and the image printed on printing paper. As a result, for example, even if a pathological determination is possible on the display section as a result of performing a specific gamma correction on the image such that the target area is photo-taken, it is difficult to faithfully print out the image displayed on the display section. Consequently, medical diagnosis is difficult at a place where there is no display section.

It is desirable to provide a display adjustment apparatus and method capable of performing gamma correction on an input image, displaying the gamma-corrected image on a display section, and faithfully printing out the gamma-corrected image displayed on the display section, a program for use therewith, and an image display print system for use therewith.

According to an embodiment of the present invention, there is provided a display adjustment method including the steps of: inputting an image; changing the luminance value of the image input in the input step on the basis of a predetermined adjustment parameter; outputting an image whose luminance value is changed in the luminance value changing step; and outputting an adjustment parameter used when the luminance value of the image is changed in the luminance value changing step.

According to another embodiment of the present invention, there is provided a display adjustment apparatus including: an adjustment parameter storage section storing a plurality of adjustment parameters for changing the luminance value of an image; and a selection section selecting a predetermined adjustment parameter from adjustment parameters stored in the adjustment parameter storage section, wherein the luminance value changing section changes the luminance value of the image input by the input section on the basis of the adjustment parameter selected by the selection section, and the adjustment parameter output section outputs the adjustment parameter selected by the selection section.

### BRIEF DESCRIPTION OF THE DRAWINGS

FIG. 1 is a block diagram showing the configuration of an image display print system according to an embodiment of the present invention;

FIG. 2 shows an example of a correction curve used when a gamma correction is performed in a display device provided in the image display print system according to the embodiment of the present invention;

FIG. 3 shows a situation in which luminance characteristics of the display device are cancelled by luminance characteristics of a correction processing device;

FIG. 4 shows gamma characteristics of a printing device;

FIG. 5 shows an example of a correction curve used when a correction process is performed in a printing device provided in the image display print system according to the embodiment of the present invention;

FIG. 6 shows the configuration of an image correction section provided in the printing device;

FIGS. 7A, 7B, and 7C are block diagrams showing a first pattern of an image signal correction section;

FIGS. 8A and 8B are block diagrams showing a second pattern of the image signal correction section;

FIGS. 9A and 9B are block diagrams showing a third pattern of the image signal correction section;

FIG. 10 is a block diagram showing a fourth pattern of the image signal correction section;

FIG. 11 is a block diagram showing the configuration of a halftoning section;

FIG. 12 is a flowchart illustrating the operation of the image display print system according to the embodiment of the present invention;

FIGS. 13A and 13B show an original image captured by an imaging device and a processed image; and

FIG. 14 is an illustration when a correction curve function is manually operated using a pointing device.

### DESCRIPTION OF THE PREFERRED EMBODIMENTS

A description will now be given below of an image display print system including a correction processing device for performing a correction process on an input image, a display device for displaying the image after the correction process, and a printing device for printing out the image displayed on the display apparatus.

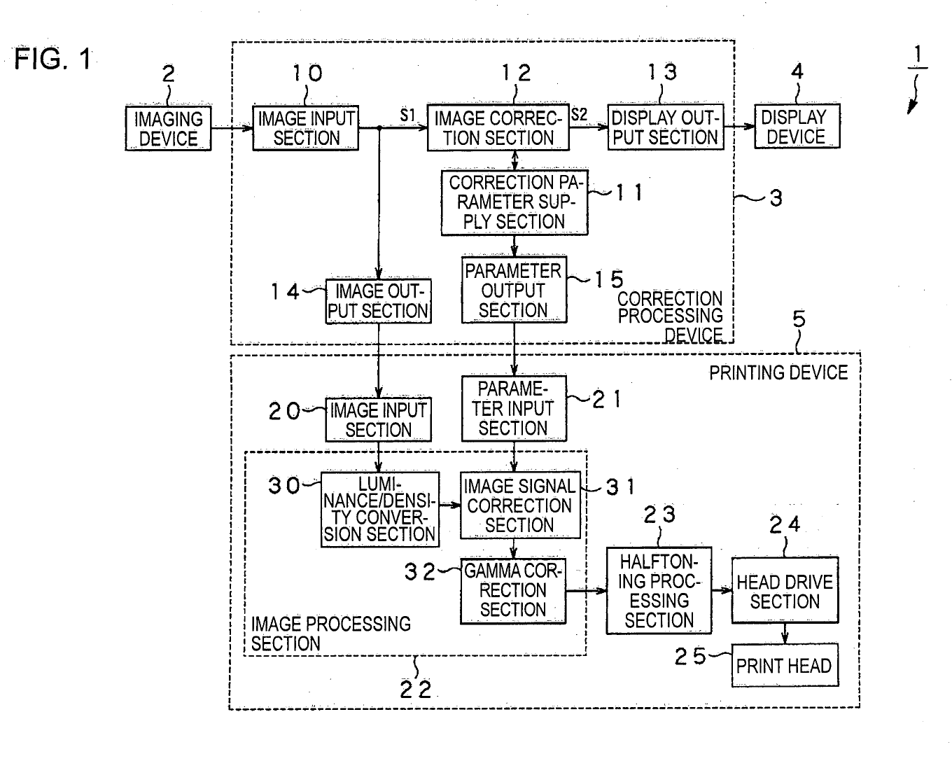

As shown in FIG. 1, an image display print system 1 includes an imaging device 2 for performing imaging of a subject, a correction processing device 3 for performing a correction process on the image captured by the imaging device 2, a display device 4 for displaying an image on which a correction process is performed, and a printing device 5 for performing a predetermined process on an image supplied via the correction processing device 3 and for faithfully printing out the image displayed on the display device 4.

The imaging device 2 is a device, such as an X-ray imaging device and a magnetic resonance imaging (MRI) device, for photo-taking target areas of a patient. The imaging device 2 supplies the photo-taken image to the correction processing device 3.

The correction processing device 3 includes an image input section 10 for inputting an image, a correction parameter supply section 11 for supplying a correction parameter for correcting the luminance value of the image, an image correction section 12 for correcting the image on the basis of the correction parameter generated by the correction parameter supply section 11, a display output section 13 for outputting the corrected image to the display device 4, an image output section 14 for outputting the image input from the image input section 10, and a parameter output section 15 for outputting the correction parameter supplied from the correction parameter supply section 11.

The image correction section 12 and the image output section 14 are connected to the image input section 10. The image input section 10 generates an image signal S1 by performing a predetermined process on the image supplied from the imaging device 2 and supplies the generated image signal S1 to the image correction section 12 and the image output section 14.

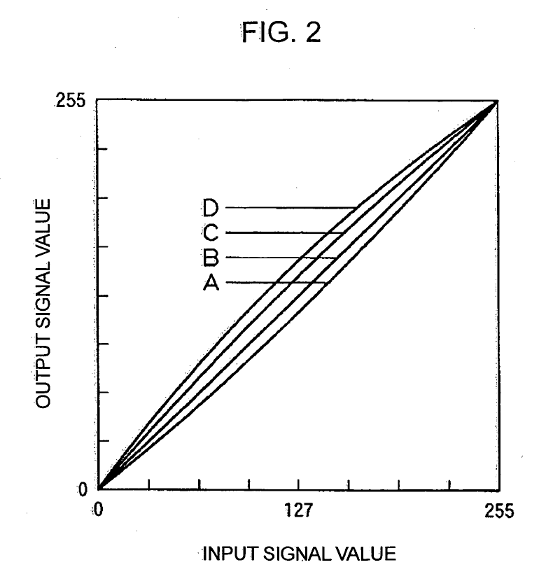

The correction parameter supply section 11 supplies a predetermined correction parameter to the image correction section 12 and the parameter output section 15. The correction parameter supply section 11 may also be configured to generate a predetermined correction parameter on the basis of a signal supplied from an operation section (not shown) and to supply the generated correction parameter to the image correction section 12 and the parameter output section 15 (hereinafter referred to as a “first configuration”). Furthermore, the correction parameter supply section 11 may be configured in such a way that, as shown in FIG. 2, correction parameters having different correction values (correction curves) are set in advance, one correction curve is-selected on the basis of the signal supplied from the operation section, and the selected correction curve is supplied as a correction parameter to the image correction section 12 and the parameter output section 15 (hereinafter referred to as a “second configuration”). Furthermore, the correction parameter. supply section 11 may also be configured to be capable of selecting the first configuration and the second configuration. In FIG. 2, the correction curve A is darkest, and the correction curve B, the correction curve C, and the correction curve D are brighter in that order.

Based on the correction parameter supplied from the image correction section 12, the image correction section 12 performs a gamma correction process on the image signal S1 supplied from the image input section 10, and supplies an image signal S2 after the gamma correction process to the display output section 13.

The display output section 13 outputs the image signal S2 supplied from the image correction section 12 to the display device 4. The image output section 14 outputs the image input via the image input section 10 to the printing device 5. The image supplied to the printing device 5 may also be directly supplied from the imaging device 2.

The parameter output section 15 outputs the correction parameter supplied from the correction parameter supply section 11 to the printing device 5.

The display device 4 is, for example, a cathode ray tube (CRT), and displays an image supplied from the correction processing device 3. In the display device 4, luminance characteristics represented by the ratio of an output signal to an input signal is not linearly proportional and has exponential-function-like characteristics. This exponential-function-like curve is called the gamma of the display device 4. Therefore, when an image is to be input to the display device 4, distortion in the gradation needs to be corrected (gamma corrected) in order to make the luminance characteristics to be linearly proportional.

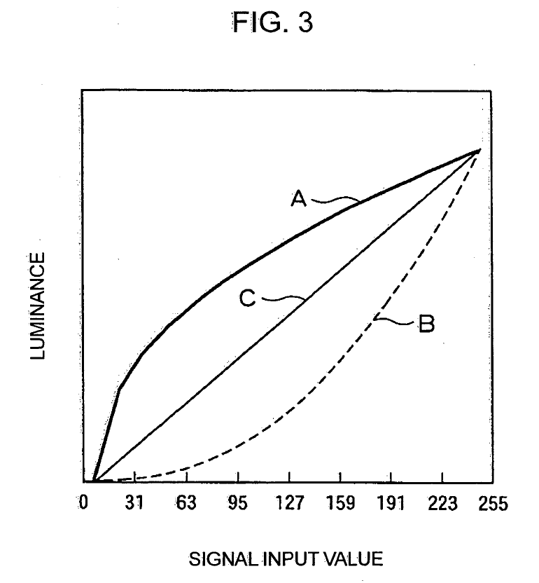

The relationship between the representative gamma curve of the display device 4 and the correction curve thereof is shown in FIG. 3. The correction curve is a curve having characteristics inverse to those of the gamma curve. Therefore, as a result of inputting, to the display device 4, the image signal (the curve A shown in FIG. 3) on which a correction process using a correction curve is performed, the effect of the gamma curve (the curve B shown in FIG. 3) of the display device 4 can be cancelled, and the reproduction of the gradation with respect to the input signal can be maintained substantially in a straight-line manner (the curve C shown in FIG. 3) from dark to bright. In this embodiment, such a correction process is performed by the correction processing device 3. However, the correction process may also be performed by the display device 4. The curve B shown in FIG. 3 is a curve when gamma is 2.2.

The printing device 5 includes an image input section 20 for inputting an image, a parameter input section 21 for inputting a correction-parameter output from the parameter output section 15, an image processing section 22 for performing a predetermined correction process on the image input via the image input section 20 on the basis of the correction parameter input via a parameter input section 21, a halftoning processing section 23 for performing a halftoning process on the basis of the image after the correction process, and a head drive section 24 for driving a print head 25 on the basis of the data after the halftoning process. In this embodiment, as an example of the printing device 5, a monochrome printer capable of printing out with multi gradation is employed. However, of course, the printing device 5 is not restricted to a monochrome printer, and a monochrome color printer and a full-color printer can also be employed.

The image input section 20 accepts an image supplied from the image output section 14, and also may accept an image that is directly supplied from the imaging device 2.

The image processing section 22 includes a luminance/density conversion section 30 for converting the luminance value of an image signal into a predetermined density value on the basis of the image input via the image input section 20; an image-signal correction section 31 for correcting an image signal that is converted into a predetermined density value in the luminance/density conversion section 30 on the basis of the adjustment curve that is selected on the basis of a correction parameter supplied from the parameter input section 21; and a gamma correction section 32 for performing gamma correction on the image signal after the adjustment process.

The luminance/density conversion section 30 inverts the luminance value of the image signal supplied from the image input section 20 so as to be converted into a density value.

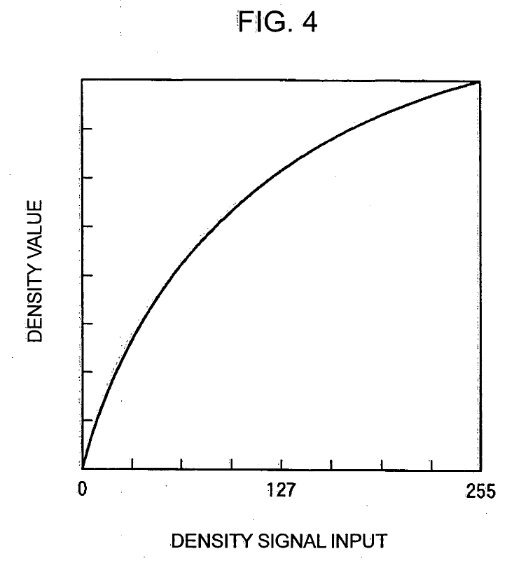

In the printing device 5, as shown in FIG. 4, there is a relationship along a saturation curve (gamma curve) between the gradation of the image signal converted into a density value by the luminance/density conversion section 30 and the gradation reproduced by the image (hereinafter referred to as a “printed image”) obtained by print-out. As a result, if the density data of the original image is directly printed out, a discrepancy occurs in the gradation reproduction characteristics between the printed image and the original image. For this reason, it is necessary to secure linearity in the gradation reproduction by performing a correction process (gamma correction) on the image signal converted into a density value using a curve having characteristics inverse to those of the gamma curve.

The gamma correction in the printing device 5 is conceptually identical to the gamma correction in the display device 4. However, in the case of the display device 4, the gamma correction is a correction with respect to the luminance value, whereas in the case of the printing device 5, the gamma correction is a correction with respect to the printing density. That is, the printing device 5 has the properties such that, as the level of the image signal that is input increases, the luminance becomes saturated, that is, the brightness becomes a maximum. However, the printing device 5 has the properties such that, as the level of the image signal that is input increases, the density becomes saturated, that is, the darkness becomes a maximum.

In the gamma correction section 32, a gamma correction process is performed on the image signal by considering such differences in properties.

In general, the gamma characteristics of the display device 4 and the gamma characteristics of the printing device 5 do not match. Therefore, a mismatch of gradation occurs between the displayed image after gamma correction, which is displayed on the display device 4 and the printed image after gamma correction, which is output by the printing device 5.

Therefore, in the image-signal correction section 31, in order to solve the above-described mismatch of gradation and achieve luminance and density matching, a correction process is performed on the image signal converted into a density value in the luminance/density conversion section 30 on the basis of the correction parameter when the image correction section 12 performs a gamma correction process on the image signal S1.

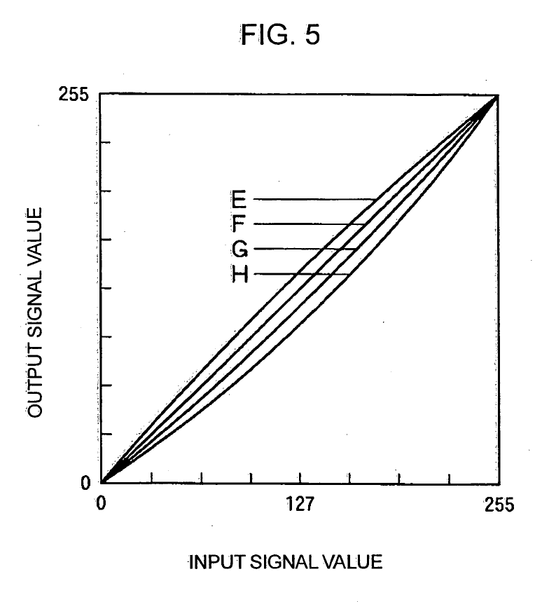

For example, one of the correction curves shown in FIG. 2 is supplied as a correction parameter to the image-signal correction section 31 via the parameter input section 21. The correction curve corresponding to the supplied correction curve is selected, and based on the selected correction curve, a correction process is performed on the image signal. In FIG. 5, the correction curve E is printed denser (dark), and the correction curve F, the correction curve G, and the correction curve H are printed lighter (brighter) in that order.

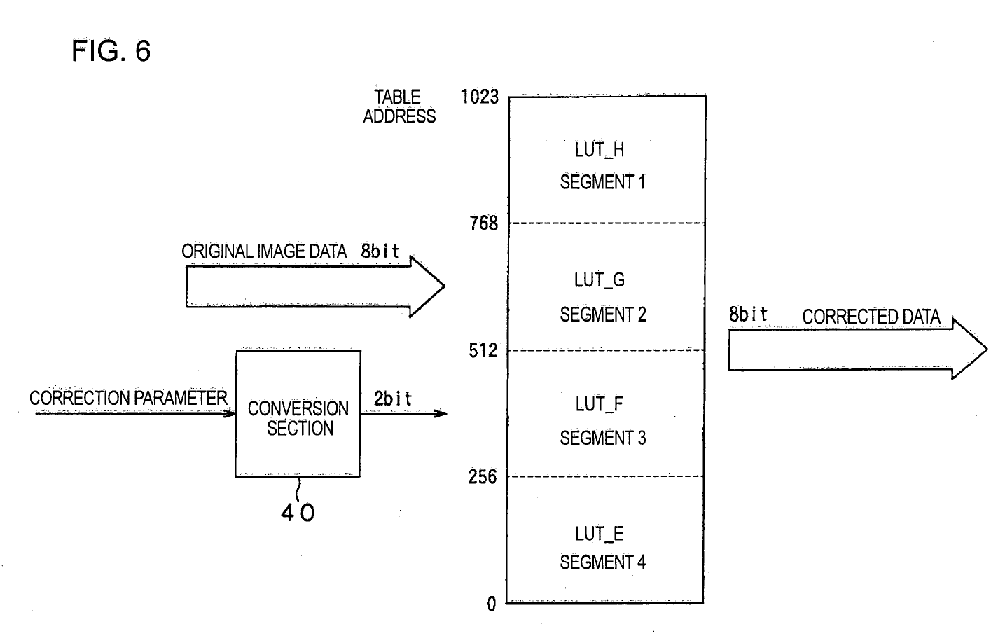

More specifically, in the image-signal correction section 31, as shown in FIG. 6, each correction curve is formed of an addressable LUT (look-up table), the correction parameter supplied from the parameter input section 21 is converted into a predetermined signal (2 bits) by a conversion section 40, and based on the LUT specified by the converted signal, a correction process is performed on the converted image signal supplied from the luminance/density conversion section 30.

For example, the correction curve E corresponds to LUT_E specified by the addresses 0 to 255, the correction curve F corresponds to LUT_F specified by the addresses 256 to 511, the correction curve G corresponds to LUT_G specified by the addresses 512 to 767, and the correction curve H corresponds to LUT_H specified by the addresses 768 to 1023. When the correction parameter is converted as “00” in the conversion section 40, LUT_E is specified; when the correction parameter is converted as “01”, LUT_F is specified; when the correction parameter is converted as “10”, LUT_G is specified; and when the correction parameter is converted as “11”, LUT_H is specified.

In the image processing section 22, the luminance/density conversion section 30, the image-signal correction section 31, and the gamma correction section 32 may be provided independently of each other (hereinafter referred to as a “first pattern”). The luminance/density conversion section 30 and the image-signal correction section 31 may be integrally coupled with each other (hereinafter referred to as a “second pattern”). The image-signal correction section 31 and the gamma correction section 32 may be integrally coupled with each other (hereinafter referred to as a “third pattern”). All the luminance/density conversion section 30, the image-signal correction section 31, and the gamma correction section 32 may be integrally coupled with one another (hereinafter referred to as a “fourth pattern”).

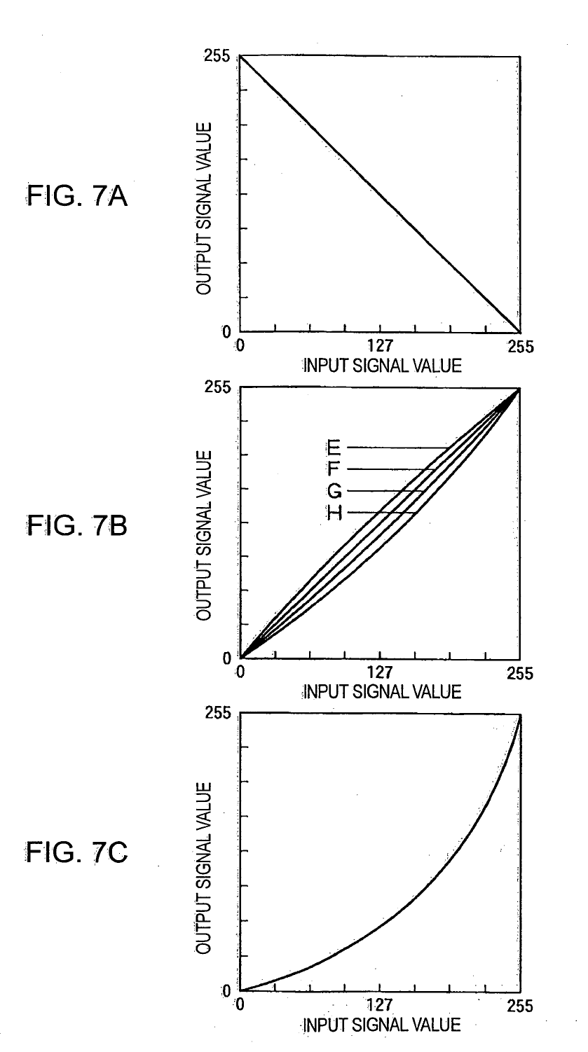

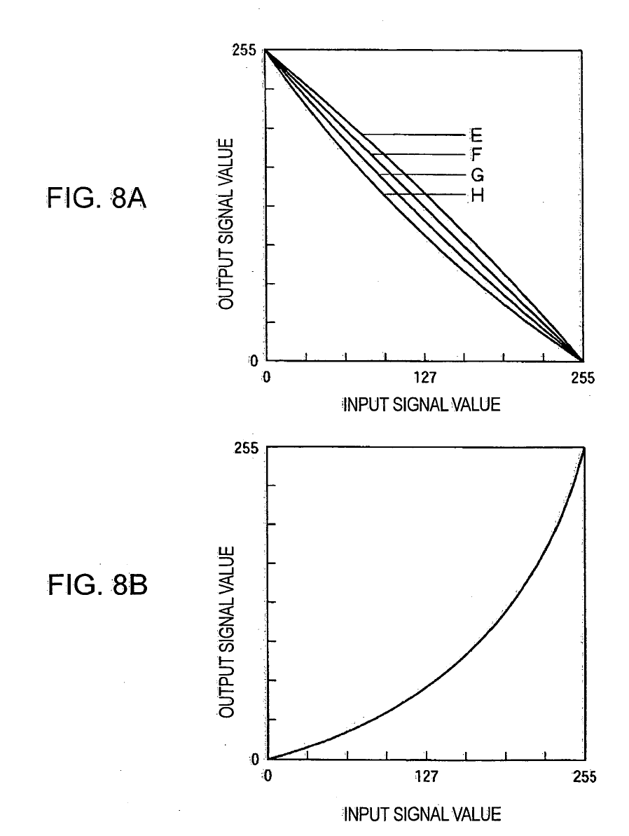

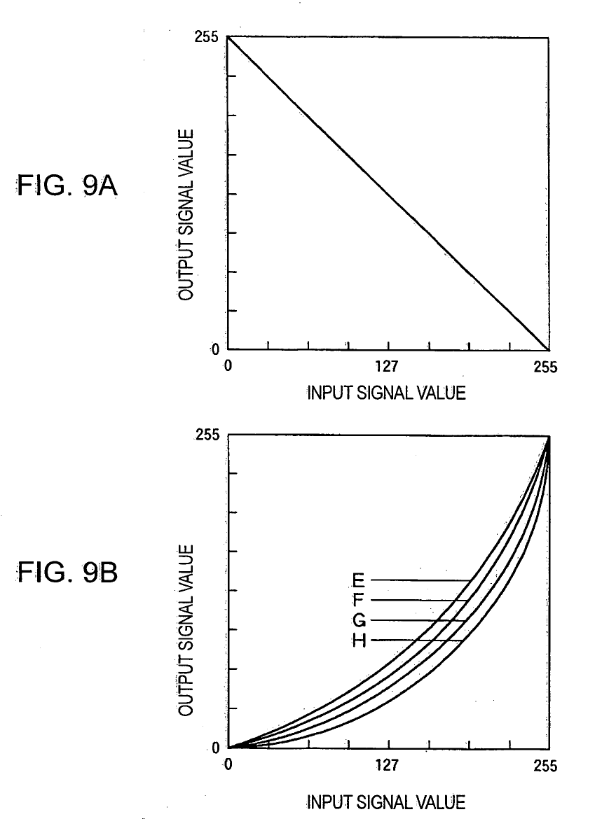

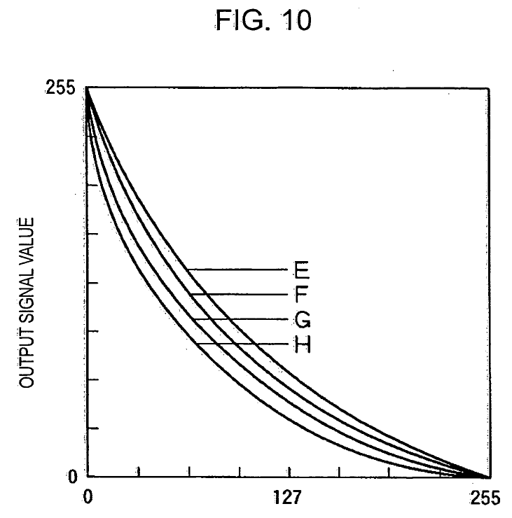

In the case of the first pattern, as shown in FIGS. 7A, 7B, and 7C, the luminance/density conversion section 30 may be formed by an LUT shown in FIG. 7A, the image-signal correction section 31 may be formed by an LUT shown in FIG. 7B, and the gamma correction section 32 may be formed by an LUT shown in FIG. 7C. In the case of the second pattern, as shown in FIGS. 8A and 8B, the luminance/density conversion section 30 and the image-signal correction section 31 that are coupled may be formed by an LUT shown in FIG. 8A, and the gamma correction section 32 may be formed by an LUT shown in FIG. 8B. In the case of the third pattern, as shown in FIGS. 9A and 9B, the luminance/density conversion section 30 may be formed by an LUT shown in FIG. 9A, and the image-signal correction section 31 and the gamma correction section 32 that are coupled may be formed by an LUT shown in FIG. 9B. In the case of the fourth pattern, the luminance/density conversion section 30, the image-signal correction section 31, and the gamma correction section 32 that are integrated may be formed by an LUT shown in FIG. 10.

Next, a description is given of the configuration of a halftoning section 23. The halftoning section 23 performs a halftoning process for reproducing halftone by a cluster of ink droplets on the basis of the image signal after a correction process, which is supplied from the image processing section 22 configured as described above, for example, by an error diffusion method.

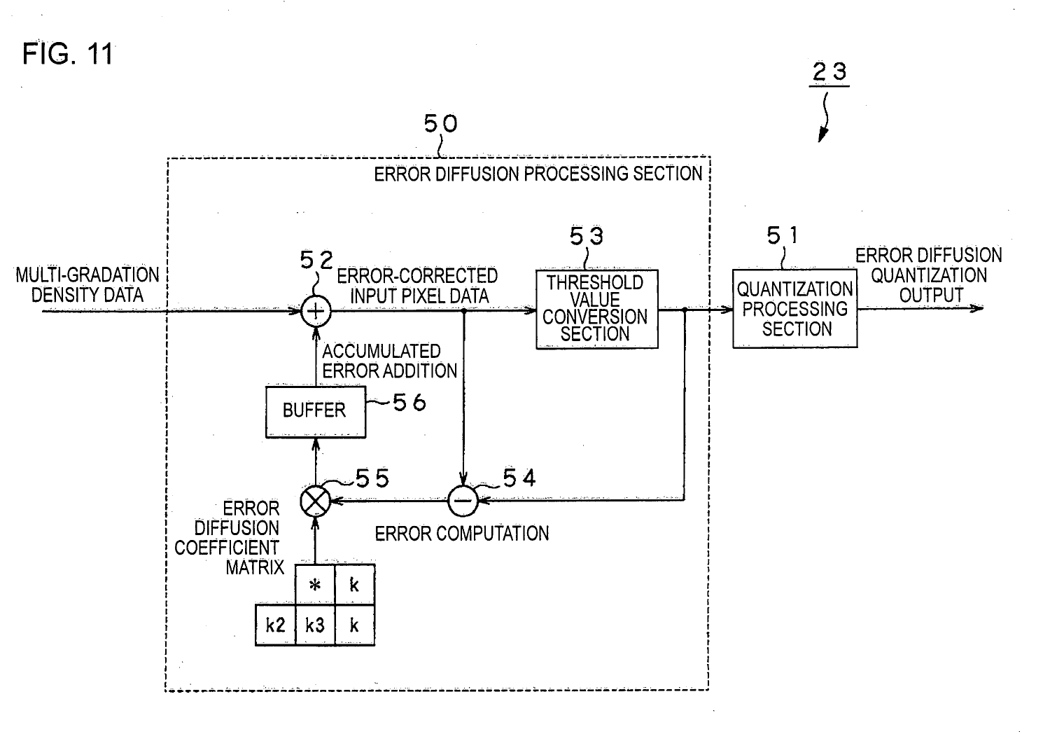

As shown in FIG. 11, the halftoning section 23 includes an error diffusion processing section 50 for-performing a predetermined error diffusion process on the image signal after a correction process, which is supplied from the image-signal correction section 31; and a quantization processing section 51 for performing a quantization process on the image signal on which an error diffusion process is performed. The halftoning section 23 supplies the signal after the quantization process to the head drive section 24.

The error diffusion processing section 50 includes an addition section 52 for adding a predetermined accumulated error value to the image signal after a correction process, which is supplied from the image processing section 22; a threshold value conversion section 53 for converting the addition value added by the addition section 52 into a predetermined threshold value on the basis of a predetermined threshold value table; a subtraction section 54 for subtracting the threshold value converted by the threshold value conversion section 53 from the addition value added by the addition section 52; a multiplication section 55 for multiplying the subtraction value subtracted by the subtraction section 54 by a predetermined error diffusion coefficient matrix; and a buffer 56 for buffering the multiplication value multiplied by the multiplication section 55 and for supplying the multiplication value buffered in the addition section 52 at a predetermined timing.

The head drive section 24 controls the driving of the print head 25 on the basis of an image signal supplied from the halftoning section 23. The print head 25 prints an image on printing paper under the driving control of the head drive section 24.

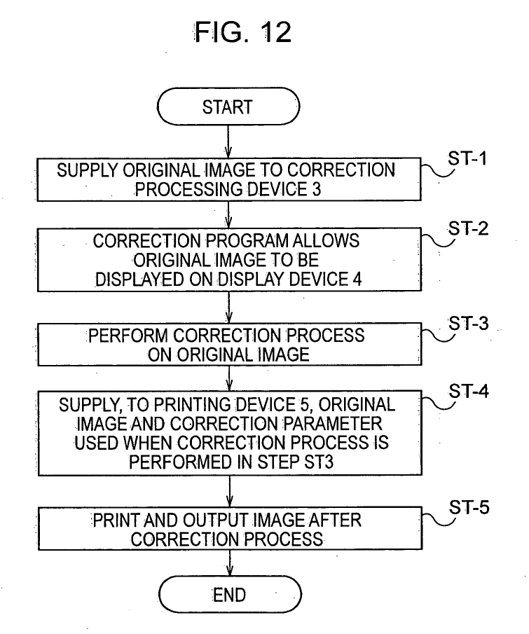

A description is given, with reference to a flowchart in FIG. 12, of a specific operation of the image display print system 1. In the following description, the operation of each component provided in the correction processing device 3 is implemented by a predetermined image correction program (hereinafter referred to as a “correction program”).

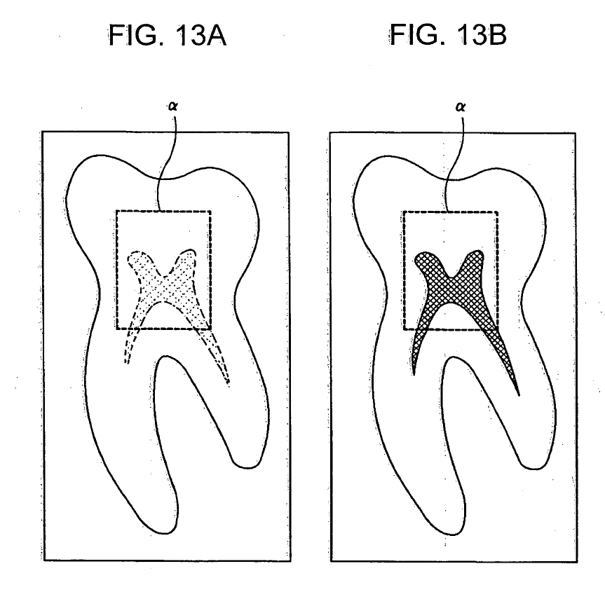

In step ST1, an image (hereinafter referred to as an “original image”) captured by the imaging device 2 by the operation of the user is supplied to the correction processing device 3. The user performs imaging of an X-ray imaging image (monochrome image) of a tooth, shown in FIG. 13A, using the imaging device 2, and supplies the image to the correction processing device 3.

In step ST2, the correction processing device 3 starts up the correction program in accordance with the operation of the user, and allows the original image supplied from the imaging device 2 in step ST1 to be displayed on the display device 4.

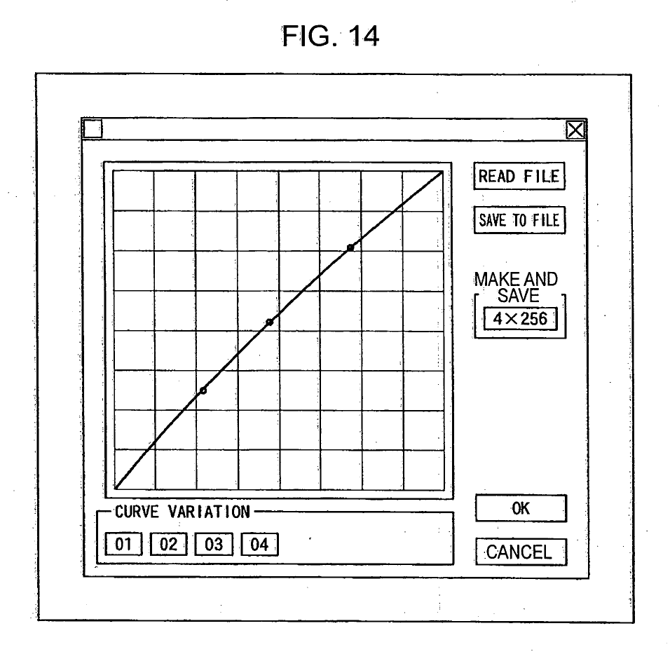

In step ST3, the correction processing device 3 performs a correction process on the original image in accordance with the operation of the user. For example, of the original image shown in FIG. 13A, in order to observe in detail the portion a surrounded by the data line, the user performs a predetermined operation by taking note of that portion α. The correction processing device 3 generates a predetermined correction parameter in:accordance with the operation of the user and performs a correction process on the original image on the basis of the correction parameter. The user performs a predetermined operation on the correction processing device 3 so that the display image becomes a desired form while viewing the display image displayed on the display device 4. Then, in accordance with the operation of the user, as shown in, for example, FIG. 13B, the correction processing device 3 allows the image in which the gradation (luminance) of the portion a is shown in detail to be displayed on the display device 4. Furthermore, the user may generate a correction parameter by changing the correction curve function shown in FIG. 14 to a desired curve by an manual operation, such as drag-and-drop, by using a pointing device.

In step ST4, in accordance with the operation of the user, the correction processing device 3 supplies, to the printing device 5, the original image input from the imaging device 2 and the correction parameter used when the correction process is performed on the original image in step ST3.

In step ST5, the printing device 5 performs a predetermined correction process on the original image on the basis of the correction parameter supplied from the correction processing device 3, and prints out the image after the correction process. The printing device 5 converts the original image from luminance into density, performs luminance/density matching with respect to the converted image on the basis of the correction parameter supplied from the correction processing device 3, and performs a predetermined correction process on the image after the luminance/density matching.

As described above, the image display print system 1 according to the embodiment of the present invention supplies the original image captured by the imaging device 2 to the correction processing device 3. The correction processing device 3 performs a correction process on the original image on the basis of a predetermined correction parameter and outputs the image after the correction process to the display device 4. Also, the printing device 5 performs luminance/density matching on the original image, and prints out the image by performing a predetermined correction process on the image on which the luminance/density matching has been performed. As a result, the degree of gradation of the display image displayed on the display device 4 can be made to match the degree of gradation of the printed image printed output by the printing device 5. For example, when an image in which the target area of a patient is photo-taken is displayed on the display device 4 and the gradation of the display image is corrected to multi gradation to such a degree that pathological determination is possible by taking note of a portion of the display image, a printed image having the same gradation as that of the display image can be obtained.

It should be understood by those skilled in the art that various modifications, combinations, sub-combinations and alterations may occur depending on design requirements and other factors insofar as they are within the scope of the appended claims or the equivalents thereof.

1. A display adjustment apparatus comprising:
an input section inputting an image;
a luminance value changing section changing the luminance value of the image input by the input section on the basis of a predetermined adjustment parameter;
an image output section outputting an image whose luminance value is changed by the luminance value changing section; and
an adjustment parameter output section outputting an adjustment parameter used when the luminance value of the image is changed by the luminance value changing section.

2. The display adjustment apparatus according to claim 1, further comprising:
an adjustment parameter storage section storing a plurality of adjustment parameters for changing the luminance value of the image; and
a selection section selecting a predetermined adjustment parameter from adjustment parameters stored in the adjustment parameter storage section,
wherein the luminance value changing section changes the luminance value of the image input by the input section on the basis of the adjustment parameter selected by the selection section, and
the adjustment parameter output section outputs the adjustment parameter selected by the selection section.

3. The display adjustment apparatus according to claim 1, further comprising an adjustment parameter generation section generating an adjustment parameter for changing the luminance value of the image,
wherein the luminance value changing section changes the luminance value of the image input by the input section on the basis of the adjustment parameter generated by the adjustment parameter generation section, and
the adjustment parameter output section outputs an adjustment parameter generated by the adjustment parameter generation section.

4. A display adjustment method comprising the steps of:
inputting an image;
changing the luminance value of the image input in the input step on the basis of a predetermined adjustment parameter;
outputting an image whose luminance value is-changed in the luminance value changing step; and
outputting an adjustment parameter used when the luminance value of the image is changed in the luminance value changing step.

5. The display adjustment method according to claim 4, further comprising the steps of:
storing a plurality of adjustment parameters for changing the luminance value of the image; and
selecting a predetermined adjustment parameter from adjustment parameters stored in the adjustment parameter storage step,
wherein the luminance value change step changes the luminance value of the image input in the input step on the basis of the adjustment parameter selected in the selection step, and
the adjustment parameter output step outputs the adjustment parameter selected in the selection step.

6. The display adjustment method according to claim 4, further comprising the step of generating an adjustment parameter for changing the luminance value of the image,
wherein the luminance value change step changes the luminance value of the image input in the input step on the basis of the adjustment parameter generated in the adjustment parameter generation step, and
the adjustment parameter output step outputs an adjustment parameter generated in the adjustment parameter generation step.

7. A program for enabling a computer to execute the steps of:
inputting an image;
changing the luminance value of the image input in the input step on the basis of a predetermined adjustment parameter;
outputting an image whose luminance value is changed in the luminance value changing step; and
outputting an adjustment parameter used when the luminance value of the image is changed in the luminance value changing step.

8. The program according to claim 7, further comprising the steps of:
storing a plurality of adjustment parameters for changing the luminance value of the image; and
selecting a predetermined adjustment parameter from adjustment parameters stored in the adjustment parameter storage step,
wherein the luminance value change step changes the luminance value of the image input in the input step on the basis of the adjustment parameter selected in the selection step, and
the adjustment parameter output step outputs the adjustment parameter selected in the selection step.

9. The program according to claim 7, further comprising the step of generating an adjustment parameter for changing the luminance value of the image,
wherein the luminance value change step changes the luminance value of the image input in the input step on the basis of the adjustment parameter generated in the adjustment parameter generation step, and
the adjustment parameter output step outputs an adjustment parameter generated in the adjustment-parameter generation step.

10. An image display print system comprising:
an input section inputting an image;
a luminance value changing section changing the luminance value of the image input by the input section on the basis of a predetermined adjustment parameter;
an image output section outputting an image whose luminance value is changed by the luminance value changing section;
an image display section displaying an image output from the image output section;
an adjustment parameter output section outputting an adjustment parameter used when the luminance value of the image is changed by the luminance value changing section;
a conversion section converting the adjustment parameter output from the adjustment parameter output section into a correction parameter;
a correction processing section performing a correction process on the image on the basis of the correction parameter converted by the conversion section; and
a print-out section printing out an image on which a correction process is performed by the correction processing section.

11. The image display print system according to claim 10, further comprising:
an adjustment parameter storage section storing a plurality of adjustment parameters for changing the luminance value of the image; and
a selection section selecting a predetermined adjustment parameter from adjustment parameters stored in the adjustment parameter storage section,
wherein the luminance value changing section changes the luminance value of the image input by the input section on the basis of the adjustment parameter selected by the selection section, and
the adjustment parameter output section outputs the adjustment parameter selected by the selection section.

12. The image display print system according to claim 10, further comprising an adjustment parameter generation section generating an adjustment parameter for changing the luminance value of the image,
wherein the luminance value changing section changes the luminance value of the image input by the input section on the basis of the adjustment parameter generated by the adjustment parameter generation section, and
the adjustment parameter output section outputs an adjustment parameter generated by the adjustment parameter generation section.
